(19) United States
(12) Patent Application Publication
(10) Pub. No.: US 2008/0267432 A1
(43) Pub. Date: Oct. 30, 2008

(54) Book with two speakers for generating a sound-field having two or more spatial dimensions

(76) Inventor: James Becker, Bellevue, WA (US)

Correspondence Address: John M. Janway, 3031 NW 64th Street, Seattle, WA, 98107, US

(21) Appl. No.: 11/789,892

(22) Filed: Apr. 25, 2007

(51) Int. Cl. H04R 5/02

(52) U.S. Cl. 381/300

(57) ABSTRACT

A book comprises two or more pages at least one of which is operable to visually display information about a subject, a first speaker mounted to a first page and operable to generate a sound, a second speaker mounted to a second page and operable to generate a sound, and an audio device operable to cause the first speaker to generate a first sound and the second speaker to generate a second sound, wherein the first and second sounds generate a sound-field having more than one spatial dimension. By generating a sound-field having more than one spatial dimension, the book can provide a reader an aural experience that is more accurate with the actual aural experience of the book's subject or aspect of the subject. Thus, the reader is more likely to accurately comprehend and appreciate the information that the book provides.

### BACKGROUND

Many books include an audio system to supplement the information that the book's text provides a reader. The audio system typically includes a speaker to generate sounds for the reader to aurally perceive, and an audio component for causing the speaker to generate the sounds. For example, children's books often have an audio system that can say a word written on a page of the book to help the child learn the word. Other examples include books that have an audio component to provide sound effects, such as POW!, KABOOM!, a lion's roar, a bird's song, and waves crashing ashore.

Unfortunately, the audio systems of these books often aurally express sounds in such a way that the reader perceives the sounds as coming from a single location. This occurs because the sounds expressed by the audio system generate a sound-field that defines a single spatial dimension, which is perceived by the reader. For example, a person listening to a single-speaker radio playing music from an AM station perceives the music as coming from the location of the single speaker. The music from the speaker generates a sound-field in which the person perceives the music coming from a single location—the speaker's location—and thus, the sound-field defines a single spatial dimension. If the radio plays music from an AM station and includes two speakers, the sound-field generated by the music defines a single spatial dimension because the listener perceives the music as coming from a single location that is between the speakers. In contrast, a person listening to a two-speaker stereo playing music from an FM station perceives the music as coming from an area extending from his/her left to right. The music from the two-speaker stereo generates a sound-field that defines two spatial dimensions.

FIG. 1 shows an example of a conventional book 10 that includes an audio system 12 to aurally express sounds. The audio system 12 includes two speakers 14 and 16 that generate sounds, and an audio component 18 that causes the speakers 14 and 16 to generate a sound. Even though the system 12 includes two speakers 14 and 16, the audio component 18 causes each speaker to simultaneously generate the same sound. Therefore, the sound-field generated by the sounds from the two speakers 14 and 16 defines a single spatial dimension.

If the subject of the book 10 involved waves in the ocean and the audio system 12 provided the reader sounds of waves crashing ashore, the reader's experience would be limited because the aural experience would not be accurate. The sound-field generated by the audio system 12 would define a single spatial dimension, and thus the sound-field would not mimic the two and maybe three dimensional sound-field that the reader would experience if the reader was located at the shore. Furthermore, an inaccurate sound-field of waves crashing ashore can hinder the reader from mentally transporting himself/herself to the shore by causing the reader to recognize the sound-field's deficiencies. When the reader's experience is limited, the reader is less likely to accurately comprehend and appreciate the information that the book 10 provides.

### SUMMARY

In one aspect of the invention, a book comprises two or more pages at least one of which is operable to visually display information about a subject, a first speaker mounted to a first page and operable to generate a sound, a second speaker mounted to a second page and operable to generate a sound, and an audio device operable to cause the first speaker to generate a first sound and the second speaker to generate a second sound, wherein the first and second sounds generate a sound-field having more than one spatial dimension. By generating a sound-field having more than one spatial dimension, the book can provide a reader an aural experience that is more accurate with the actual aural experience of the book's subject or aspect of the subject. Thus, the reader is more likely to accurately comprehend and appreciate the information that the book provides.

### BRIEF DESCRIPTION OF THE FIGURES

FIG. 1 is a perspective view of a conventional book.

FIG. 2 is a perspective view of a book according to an embodiment of the invention.

FIG. 3 is a perspective view of the book in FIG. 2 shown closed.

FIG. 4 is a schematic diagram of an audio system of the book in FIGS. 2 and 3, according to an embodiment of the invention.

FIG. 5 is a perspective view of a book according to another embodiment of the invention.

### DETAILED DESCRIPTION

Various modifications to the disclosed embodiments will be readily apparent and the generic principles herein may be applied to other embodiments and applications without departing from the spirit and scope of the present discussion. Thus, the present discussion is not intended to be limited to the embodiments shown, but is to be accorded the widest scope consistent with the principles and features disclosed herein.

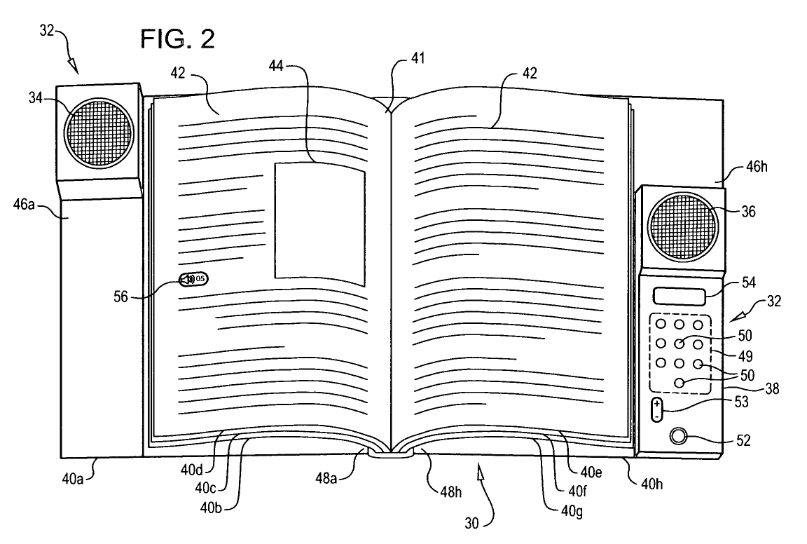

FIG. 2 is a perspective view of a book 30 according to an embodiment of the invention. The book 30 includes an audio system 32 that can generate a sound-field defining more than one spatial dimension. The system 32 includes a first speaker 34, a second speaker 36, and an audio device 38 to cause the first speaker 34 to generate a first sound and to cause the second speaker 36 to generate a second sound. The first and second sounds then combine to generate a sound-field having more than one spatial dimension, such as a two-dimensional sound-field like that generated by a stereo receiver playing an FM stereo radio signal. With an audio system 32 that can generate a sound field having two or more spatial dimensions, the book 30 can provide a reader an aural experience of an event that more closely matches an actual aural experience of the event. Thus, the reader is more likely to accurately comprehend, enjoy and/or appreciate the information that the book 30 provides.

The audio system 32 can generate a sound-field having more than one spatial dimension in any desired manner. For example, in this and other embodiments, the audio system 32 includes electronic circuitry (discussed in greater detail in conjunction with FIG. 4) that can process an electronic signal having sounds encoded on two discrete channels in the form of audio data, and cause the first speaker 34 to generate the sounds encoded on one of the channels, and the second speaker 36 to generate, simultaneously, the sounds encoded on the other channel. In operation, the reader perceives the sounds encoded on one of the channels as coming from the location of the first speaker 34, and the sounds encoded on the other channel as coming from the location of the second speaker 36. Because different sounds come from different locations, the sound-field generated by the sounds from both speakers 34 and 36 defines an area having two spatial dimensions, similar to a stereo playing music encoded in a stereo signal.

Other embodiments of the audio system 32 are possible. For example, the electronic circuitry can process an electronic signal having sounds encoded on three or more discrete channels, and can cause two or more speakers to generate sounds from a respective one or more of the channels. In still other embodiments, the audio system 32 can include electronic circuitry that can process an electronic signal having sounds encoded in any desired surround sound format such as 3.0 Channel Surround (Dolby Surround), 4.0 Channel Surround (Quadraphonic), 4.1 Channel Surround, 5.1 Channel Surround, 6.1 Channel Surround, 7.1 Channel Surround, 10.2 Channel Surround, and 22.2 Channel Surround. In still other embodiments, the audio system 32 can include electronic circuitry that can process an electronic signal having sounds encoded in any other desired format, such as MP3.

In still other embodiments of the audio system 32, the system 32 includes electronic circuitry that can process an electronic signal having sounds encoded in the form of audio data and that can cause the first and second speakers 34 and 36 to generate the encoded sound, but not simultaneously. For example, the delay between the first sound, which is generated by the first speaker 34, and the second sound, which is the same as the first sound but generated by the second speaker 36, can be a millisecond. In operation, the reader perceives the same sound coming from the location of the first speaker 34, and then from the location of the second speaker 36. Because the sound comes from different locations, the sound-field generated by the sound from both speakers 34 and 36 defines an area having two spatial dimensions, similar to an echo or reverberation effect.

Other embodiments are possible. For example, the delay between the first and second sounds can be any desired delay. Furthermore, the second sound can be slightly different than the first to give the generated sound-field depth or a third spatial dimension. In addition, the sounds can be encoded on more than one discrete channel, and the electronic circuitry can cause each of the speakers 34 and 36 to play the sounds encoded on all the discrete channels.

In still other embodiments of the audio system 32, the audio system includes electronic circuitry that can process an electronic signal having sounds encoded in the form of audio data, and that can cause the first and second speakers 34 and 36 to play the sounds at different volumes over a period of time. For example, at one moment in time the first speaker generates a first sound at a first volume, and the second speaker simultaneously generates a second sound that is the same as the first sound but at second volume that is different than the first volume. Then, in the next moment of time, the first speaker generates the sound at a volume less than the first volume, and the second speaker simultaneously generates the sound at a volume greater than the second volume. In operation, the reader perceives the same sound moving from the location of the first speaker 34 toward the location of the second speaker 36. Because the sound appears to move between different locations, the sound-field generated by the sound from both speakers 34 and 36 defines an area having two spatial dimensions.

Other embodiments are possible. For example, the second sound can be slightly different than the first to give the generated sound-field depth or a third spatial dimension. In addition, the sounds can be encoded on more than one discrete channel, and the electronic circuitry can cause each of the speakers 34 and 36 to play the sounds encoded on all the discrete channels.

Still referring to FIG. 2, the book 30 also includes two or more pages that visually display information about a subject of the book 30. For example in this and certain other embodiments, the book 30 includes 8 pages 40a-40h, of which one page 40a is the front cover of the book 30, and another page 40h is the back cover of the book 30. The pages 40a-40h are joined together along their respective edges to form a spine 41. The page 40d includes both text 42 and an image 44 to provide information about the subject of the book 30. And the page 40e includes text 42 to provide more information about the subject of the book 30.

The subject of the book may be any desired subject. For example, in this and certain other embodiments, the subject of the book 30 is animals of Africa. In other embodiments, the subject of the book 30 may be airplanes, or water waves.

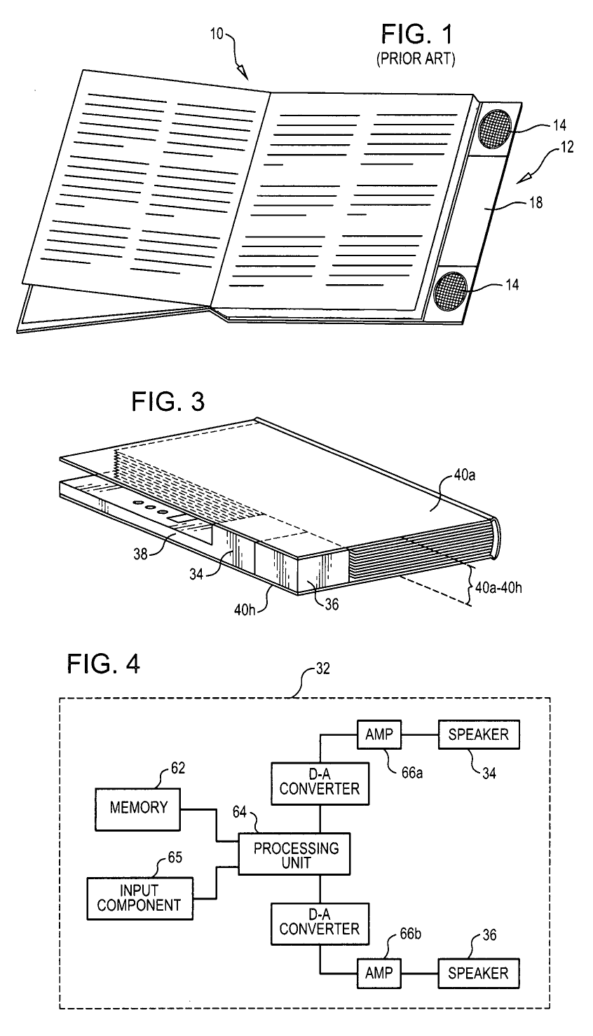

Still referring to FIG. 2, the speakers 34 and 36 may be mounted to the book 30 in any desired manner and location to provide a good sound-field defining two or more spatial dimensions. Generally, a sound-field having two or more well defined spatial dimensions is generated by speakers that are as far apart as possible, but this is not always so and depends on the sounds and desired effect to be generated. In this and certain other embodiments, for example, the speakers 34 and 36 are mounted to their respective covers 40a and 40h using any desired conventional technique such as an adhesive, stitches, rivets or some other mechanical fastening device. Furthermore, the first and second speakers 34 and 36 are mounted to respective peripheral regions 46a and 46h that are distal to respective other peripheral regions 48a and 48h where the covers 40a and 40h are joined to form a portion of the spine 41. Thus, when the book 30 is in an open position and the spine 41 lies between the covers 40a and 40h (as shown in FIG. 1), the distance between the first and second speakers 34 and 36 is greater than 80% of the distance between the edges of the respective peripheral regions 46a and 46h. That is, the distance between the first and second speakers 34 and 36 is greater than 80% of the length of the book measured perpendicular to the spine 41.

Other embodiments are possible. For example, the speakers 34 and 36 may be mounted to the same cover. In still other embodiments, one or more of the speakers 34 and 36 may be mounted to one of the other pages 40b-40g. In still other embodiments, the speakers 34 and 36 may be mounted to a respective peripheral region 48a and 48h, which are near the spine 41. In still other embodiments, one or more of the speakers 34 and 36 may be releasably-fastened to the book 30 using any desired fastening technique that allows one to remove the one or more speakers 34 and 36 from the book 30 and attach a different speaker or re-attach the same speaker to the book. For example, the speaker 36 may be releasably attached to the back cover 40h with Velcro.

Still referring to FIG. 2 the audio device 38 may be mounted to the book 30 in any desired manner and location. For example, in this and certain other embodiments, the audio device 38 is mounted to the peripheral region 46h of the cover 40h using any desired conventional technique such as an adhesive, stitches, rivets or some other mechanical fastening device. In other embodiments, the audio device 38 can mounted to other regions of the cover 40h, or to one of the other pages 40a-40g. In still other embodiments, the audio device 38 may be releasably fastened to the book 30 using any desired fastening technique that allows one to remove the device 38 from the book 30 and attach a different audio device 38 or re-attach the same audio device 38 to the book. For example, the audio device 38 may be releasably attached to the back cover 40h with Velcro.

Still referring to FIG. 2, the audio device 38 includes an input component 49 for selecting an audio track that contains the desired audio data to be played by the system 32, and can be configured as desired. For example, in this and certain other embodiments, the input component 49 includes a set of input keys 50 (10 shown but only 3 labeled with a reference number) of which one or more can be press sequentially or simultaneously to select an audio track. The audio device 38 also includes a power switch 52 to connect, as desired, a power source, such as a battery, to the device's electronic circuitry. The audio device 38 also includes a volume switch 53 to adjust the volume of the speakers 34 and 36. The device 38 also includes a display 54 for displaying information about the audio data being played, such as an identifier for the track, or information about the operation of the system 32, such as the type of method performed for generating a sound-field with two or more spatial dimensions. In this and certain other embodiments, the display 20 includes a conventional liquid crystal display (LCD).

Other embodiments are possible, for example one or more pages 40a-40h may include any desired device that triggers the audio device 38 to select and play one or more units or tracks of audio data without the user having to operate the switch 52 and the keys 50. For example the triggering device can be located in a respective page and can trigger the audio device 38 when the page containing the triggering device is moved relative to the audio device 38. In some of these embodiments, the audio device 38 may not include the switch 52, or the display 54. In addition, the display 54 may include a light emitting diode (LED) that displays the activity being performed by the circuitry and the track that is the subject of the activity.

To operate the book 30 according to this and certain other embodiments of the invention, a user opens the book 30 to a desired page, such as 40d, and perceives some or all of the information visually displayed on the page 40d. The user also perceives a symbol 56 that suggests to the user that sounds related to the visual information can be heard by using the audio system 32. The symbol 56 also identifies an audio track stored in the audio device 38 that corresponds with the information visually displayed and can be played. Then, the user turns on the audio system 32 (if off) by exerting pressure on the switch 52. Next, the user selects the audio track identified in the symbol 56 by exerting pressure on one or more of the keys 50. When the desired audio track is selected the device 38 displays the track identifier on the display 54. The circuitry of the system 32 then processes the sounds encoded in the desired audio track, and causes the speakers 34 and 36 to generate the sounds. Once the user is satisfied with the information that he/she perceives visually and aurally, the user then turns to the next the page 40e, if desired, to perceive the visually displayed information and listen to more sounds (if included) that correspond to the subject of the book or specific page 40e.

In other embodiments, a user may perceive the information displayed visually and listen to sounds in another sequence. For example, the user might first perceive the symbol 56 on the page 40d, search for and select the corresponding audio track. After hearing some or all of the audio track, the user might then perceive some or all of the information displayed visually on the page 40d. In another example, the user might perceive the visually and aurally displayed information at the same time. In other embodiments, the user may perceive the information visually displayed on a page and hear the aurally displayed information that corresponds to another page.

FIG. 3 is a perspective view of the book 30 in FIG. 2 shown in a closed position. In this and certain other embodiments, the speakers 34 and 36 are located on their respective covers 40a and 40h such that they lie adjacent each other when the book is in a closed position. By offsetting the locations of the speakers 34 and 36 relative to each other when the book 30 is in the closed position, the space available for each of the speakers 34 and 36 may be large to permit large, high fidelity speakers to be mounted to the covers 40a and 40h. In other embodiments, a large space may not be desired, and the locations of the speakers 34 and 36 relative to each other may not be offset. For example the speakers 34 and 36 may be aligned when the book 30 is in a closed position.

FIG. 4 is a schematic diagram of the audio system 32 of the book 30 in FIGS. 2 and 3, according to an embodiment of the invention. As discussed elsewhere herein, the audio system 32 includes electronic circuitry that can process an electronic signal having sounds encoded in the form of audio data, and cause the first and second speakers 34 and 36 to generate the sounds encoded in the signal.

The electronic circuitry of the audio device 38 can be any desired circuitry capable of processing the electronic signal and causing the first and second speakers 34 and 36 to generate sounds. For example, in this and certain other embodiments of the device 38, the circuitry includes a conventional circuit for controlling and distributing power generated by batteries or other means. The circuitry also includes a conventional memory circuit 62 for storing audio data, and a conventional processor circuit 64 for reading the audio data and powering the speakers 34 and 36 to generate a sound from the audio data read. The electronic circuitry also includes an input component 65 (as discussed elsewhere herein) for selecting an audio track to be played, and amplifiers 66a and 66b corresponding to speakers 34 and 36 respectively, for amplifying the electronic signal that causes the speakers 34 and 36 to generate sounds. All or a portion of the memory circuit 62 may be removable from the device 14 as desired, such as a memory stick that is releasably connected to a computer via a USB connector. In other embodiments, no portion of the memory circuit 62 is removable from the device 14.

As discussed elsewhere herein, the conventional processor circuit 62 is operable to read audio data encoded on two or more discrete channels of an electronic signal. In other embodiments, the conventional processor circuit 62 can read audio data encoded in an electronic signal and cause the speakers 34 and 36 to generate, but not simultaneously, the sounds represented by the audio data. In still other embodiments, the conventional processor circuit 62 can read audio data encoded in an electronic signal and cause the speakers 34 and 36 to generate at different volumes over a period of time, the sounds represented by the audio data. In still other embodiments, the conventional circuit 62 may be operable to perform all three types of methods for generating a sound-field having two or more spatial dimensions.

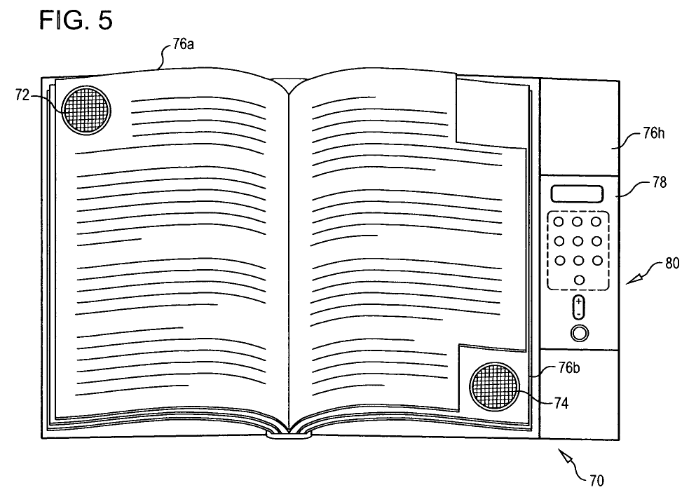

FIG. 5 is a perspective view of a book 70 according to another embodiment of the invention. The book 70 includes two speakers 72 and 74 each mounted on a page 76a and 76b, respectively, of the book 70, and an audio device 78 mounted on the back cover 76h of the book. Neither of the pages 76a and 76b is a cover of the book 70. In this embodiment, the speakers 72 and 74 are also separated in a vertical direction to allow the audio system 80, which includes the audio device 78 and the two speakers 72 and 74, to more easily or more clearly define a vertical dimension to the sound-field that the audio system 80 can generate.

From the foregoing, it will be appreciated that, although specific embodiments have been discussed herein for purposes of illustration, various modifications may be made without deviating from the spirit and scope of the discussion herein. Accordingly, the systems and methods include such modifications as well as all permutations and combinations of the subject matter set forth herein and are not limited except as by the appended claims.

What is claimed is:

1. A book comprising:
two or more pages including a first page, a second page, and at least one page that is operable to visually display information about a subject; the two or more pages joined together to form a spine;
a first speaker mounted to the first page and operable to generate a sound;
a second speaker mounted to the second page and operable to generate a sound; and
an audio device operable to cause the first speaker to generate a first sound and the second speaker to generate a second sound, wherein the first and second sounds generate a sound-field having more than one spatial dimension.

2. The book of claim 1 wherein at least one of the following: the first page and the second page, is a cover of the book.

3. The book of claim 1 wherein:
the first page is a front cover of the book,
the second page is a back cover of the book, and
while the book is open, the first speaker is remote from the second speaker.

4. The book of claim 1 wherein at least one of the following: the first page and the second page, is operable to visually display information about the subject.

5. The book of claim 1 wherein at least one of the two or more pages includes at least one of the following: text and an image, to visually display information about the subject.

6. The book of claim 1 wherein the two or more pages are joined along their respective edges to form the spine.

7. The book of claim 1 wherein the first and second speakers are mounted to their respective first and second pages such that while the book is open and the spine is disposed between the first and the second pages, the distance between the speakers is more than 80% of the length of the book measured perpendicular to the spine.

8. The book of claim 1 wherein the first page and second page each includes:
a first peripheral region where the respective page is joined to the other page, and
a second peripheral region distal to the first peripheral region where the page's respective speaker is mounted.

9. The book of claim 1 wherein the audio device is mounted to one of the following:
the first page and the second page.

10. The book of claim 1 wherein the audio device includes a component operable to select the first and second sound to be generated by the first and second speakers.

11. The book of claim 10 wherein the component includes at least one of the following:
one or more input keys to select the first and second sound to be generated, and
a switch operable by turning a page of the book.

12. The book of claim 1 wherein the sound-field includes two spatial dimensions.

13. The book of claim 1 wherein the sound-field includes three spatial dimensions.

14. The book of claim 1 wherein the first sound is different than the second sound.

15. The book of claim 1 wherein the audio device causes the first speaker to generate the first sound, and then a moment later causes the second speaker to generate the same sound.

16. The book of claim 1 wherein:
at a first moment in time the audio device simultaneously causes the first speaker to generate a sound at a first volume and the second speaker to generate a sound at a second volume that is different than the first volume,
then, at a second moment in time, the audio device simultaneously causes the first speaker to generate the sound at a volume lower than the first volume and the second speaker to generate the sound at a volume higher than the second volume.

17. The book of claim 1 wherein the first volume is equal to or substantially equal to the second volume.

18. The book of claim 1 wherein the first sound is different than the second sound, and the audio device is operable to simultaneously cause the first speaker to generate the first sound and the second speaker to generate the second sound.

19. The book of claim 1 further comprising an additional speaker mounted to one of the two or more pages and operable to generate a sound, and wherein the audio device is operable to cause the additional speaker to generate a third sound that is different than each of the first and second sounds, wherein the first, second and third sounds generate a sound-field having more than one spatial dimension.

20. The book of claim 1 wherein the subject of the book includes animals, the first sound includes a lion's roar, and the second sound includes an elephant's roar.

21. The book of claim 1 wherein the subject of the book includes horses, the first sound includes a horse galloping in a region to the left of the reader of the book, and the second sound includes the horse galloping in a region to the right of the reader.

22. A method comprising:
visually displaying information about a subject on a page of a book; and
generating a sound-field having more than one spatial dimension by causing a first speaker mounted to a first page of the book to generate a first sound, and a second speaker mounted to a second page of the book to generate a second sound.

23. The method of claim 22 wherein visually displaying information includes visually displaying information with at least one of the following; text and an image.

24. The method of claim 22 wherein an audio device mounted to a page of the book causes the first speaker to generate the first sound and the second speaker to generate the second sound.

25. The method of claim 24 further comprising selecting a first sound and a second sound by pressing one or more input-keys of the audio device.

26. The method of claim 24 further comprising selecting a first sound and a second sound by turning a page of the book.

27. The method of claim 22 wherein generating the sound-field includes simultaneously causing the first speaker to generate the first sound and the second speaker to generate a sound that is different than the first sound.

28. The method of claim 22 wherein generating the sound-field includes:
simultaneously causing the first speaker to generate a sound at a first volume and the second speaker to generate the sound at a second volume that is different than the first volume, and
then, simultaneously causing the first speaker to generate the sound at a volume lower than the first volume and the second speaker to generate the sound at a volume higher than the second volume.

29. The method of claim 22 wherein generating the sound-field includes:
causing the first speaker to generate a sound, and
then a moment later causing the second speaker to generate the same sound.
